(19) United States
(12) Patent Application Publication
(10) Pub. No.: US 2026/0147928 A1
(43) Pub. Date: May 28, 2026

(54) Detection of Sensitive Information in a Text Document

(71) Applicant: Telefonaktiebolaget LM Ericsson (publ), Stockholm (SE)

(72) Inventors: Tahar Zanouda, Solna (SE); Doumitrou Daniil Nimara, Sundbyberg (SE); Fitsum Gaim Gebre, Järfälla (SE)

(21) Appl. No.: 19/137,460

(22) PCT Filed: Jul. 19, 2023
(86) PCT No.: PCT/SE2023/050747

§ 371 Date: Jun. 10, 2025

(30) Foreign Application Priority Data
Dec. 16, 2022 (GR) 20220101045

(51) Int. Cl. G06F 21/62; G06F 40/242; G06F 40/279

(52) U.S. Cl. CPC G06F 21/6254; G06F 40/242; G06F 40/279

(57) ABSTRACT

An apparatus (300) for detecting sensitive information in a first text document representative of a first topic is provided. The apparatus (300) is configured to generate a first updated text document by tagging a segment of text in the first text document using a list of one or more types of sensitive information for a second topic: train a language model on text representative of the first topic and on a list of one or more types of sensitive information for a third topic, wherein the language model is a transformer-based machine learning model; and generate a second updated text document by classifying as sensitive a segment of text in the first updated text document using the trained language model representative of relationships between the tagged segment, one or more types of sensitive information for the third topic, and the text representative of the first topic.

### TECHNICAL FIELD

The invention relates to an apparatus for detecting sensitive information in a first text document representative of a first topic, a system for troubleshooting a computer, corresponding methods, corresponding computer programs, and a corresponding computer readable storage medium.

### BACKGROUND

The increasing complexity of cellular network technologies and rising number of Internet-of-Things (IoT) devices have led to an exponential growth in telecommunication data. Telecommunication data is collected and stored to monitor the performance of telecommunication services and to enable software and/or hardware troubleshooting efforts. However, the existence of sensitive data within telecommunication data hinders efforts to conduct troubleshooting activities or leverage certain technologies for data processing and data storage.

The process of planning, deploying, and monitoring telecommunication networks can generate a massive and heterogeneous data. Some examples of formats of datasets include Radio Access Network (RAN) logs, legal contracts. The heterogeneity of the formats of the datasets leads to difficulty to query and analyze said data.

Furthermore, in recent years, several regulators around the globe have imposed guidelines to regulate how telecommunication data is handled and stored. These guidelines and regulations are not standardized across different geographic regions (e.g., California Consumer Privacy Act in US/California, General Data Protection Regulation in Europe, etc.) and can change and evolve over time. Therefore, mobile service providers are required to comply with security guidelines and data privacy protection laws in region where they operate.

In an effort to protect sensitive information to comply with the guidelines and regulations, there have been efforts to develop rule-based systems to detect sensitive information. However, these solutions are expensive to maintain, difficult to scale across different regions that have different regional guidelines. Moreover, it is also hard to decipher semantic meaning of heterogeneous and unstructured textual data.

Similarly, there have been efforts to develop intelligent, context-based systems utilizing language models.

HASSAN F., DOMINGO-FERRER J., SORIA-COMAS J., “Anonymization of unstructured data via named-entity recognition”, September 2018, discloses different model architectures and input features for anonymization.

BRINDAL O., “Named-entity recognition with BERT for anonymization of medical records”, 2021, discloses a BERT-architecture and anonymizing medical records in Swedish.

### SUMMARY

One of the challenges of the prior approaches is assuming that sensitive information is mapped to a single word or term. However, a set of words or terms can be seen as sensitive information as well, for example an address comprising of multiple location terms.

Another challenge is that what may be considered sensitive information might differ depending on regulations that vary geographically. For example, public access to personal information such as personal address is available in Sweden, wherein a personal address is considered sensitive information in France.

Another difficulty with prior approaches is understanding semantic meaning in unstructured text document. Therefore, identifying and detecting sensitive information in an unstructured text document is challenging. Furthermore, anonymization of unstructured text document remains a manual task.

Additionally RAN logs are used for software and hardware cellular network diagnostics and troubleshooting. However, a RAN log contains sensitive information that reduce efficient ways of storing, analyzing, and sharing logs across an organization (e.g., enterprise).

An object of the invention is to improve security in text document.

According to a first aspect of the invention, an apparatus for detecting sensitive information in a first text document representative of a first topic is provided. The apparatus is configured to generate a first updated text document by tagging a segment of text in the first text document using a list of one or more types of sensitive information for a second topic. The apparatus is configured to train a language model on text representative of the first topic and on a list of one or more types of sensitive information for a third topic, wherein the language model is a transformer-based machine learning model. The apparatus is configured to generate a second updated text document by classifying as sensitive a segment of text in the first updated text document using the trained language model representative of semantic relationships between the tagged segment, one or more types of sensitive information for the third topic, and the text representative of the first topic.

According to an embodiment of the first aspect, the transformer-based machine learning model comprises a Bidirectional Encoder Representations from Transformers, BERT. The final layer of the model comprises a binary class tagging layer.

According to an embodiment of the first aspect, the list of the one or more types of sensitive information for the second topic comprises a dictionary of one or more records. Each record defines a type of sensitive information and corresponding textual pattern for identifying said type in text.

According to an embodiment of the first aspect, the list of the one or more types of sensitive information for the third topic comprises a dictionary of one or more records. Each record defines a type of sensitive information and corresponding textual tag for tagging text using said type.

According to an embodiment of the first aspect, the apparatus is further configured to replace the segments of text classified as sensitive in the second updated text document.

According to an embodiment of the first aspect, the replacing comprises anonymizing the segments of text classified as sensitive in the second updated text document.

According to an embodiment of the first aspect, the replacing comprises pseudo-anonymizing the segments of text classified as sensitive in the second updated text document.

According to an embodiment of the first aspect, the apparatus comprises a processor and a memory, the memory containing instructions executable by the processor whereby the apparatus is operative to perform the operations of one or more of the embodiments of the first aspect.

According to a second aspect of the invention, an apparatus is provided. The apparatus comprises a generating unit, and a training unit. The generating unit is configured to generate a first updated text document by tagging a segment of text in the first text document using a list of one or more types of sensitive information for a second topic. The training unit is configured to train a language model on text representative of the first topic and on a list of one or more types of sensitive information for a third topic, wherein the language model is a transfer-based machine learning model. The generating unit is configured to generate a second updated text document by classifying as sensitive a segment of text in the first updated text document using the trained language model representative of semantic relationships between the tagged segment, one or more types of sensitive information for the third topic, and the text representative of the first topic.

According to a third aspect of the invention, a system for troubleshooting a computer is provided. The system comprises an apparatus according to an embodiment of the first aspect of the invention. The first text document comprises a log and the first topic comprises operation of the computer. The sensitive information for a second topic corresponds to computer-specific sensitive information. The sensitive information for a third topic corresponds to personally identifiable information. The system is further configured to perform a troubleshooting activity prior to performing or after performing all steps configured to be performed by the apparatus.

According to a fourth aspect of the invention, a method performed by an apparatus for detecting sensitive information in a first text document representative of a first topic. The method comprises generating a first updated text document by tagging a segment of text in the first text document using a list of one or more types of sensitive information for a second topic. The method comprises training a language model on text representative of the first topic and on a list of one or more types of sensitive information for a third topic, wherein the language model is a transformer-based machine learning model. The method comprises generating a second updated text document by classifying as sensitive a segment of text in the first updated text document using the trained language model representative of semantic relationships between the tagged segment, one or more types of sensitive information for the third topic, and the text representative of the first topic.

According to an embodiment of the fourth aspect of the invention, the transformer-based machine learning model comprises a Bidirectional Encoder Representations from Transformers, BERT. The final layer of the model comprises a binary class tagging layer.

According to an embodiment of the fourth aspect of the invention, the list of the one or more types of sensitive information for the second topic comprises a dictionary of one or more records. Each record defines a type of sensitive information and corresponding textual pattern for identifying said type in text.

According to an embodiment of the fourth aspect of the invention, the list of the one or more types of sensitive information for the third topic comprises a dictionary of one or more records. Each record defines a type of sensitive information and corresponding textual tag for tagging text using said type.

According to an embodiment of the fourth aspect of the invention, the method further comprises replacing the segments of text classified as sensitive in the second updated text document.

According to an embodiment of the fourth aspect of the invention, the replacing comprises anonymizing the segments of text classified as sensitive in the second updated text document.

According to an embodiment of the fourth aspect of the invention, the replacing comprises pseudo-anonymizing the segments of text classified as sensitive in the second updated text document.

According to a fifth aspect of the invention, a method performed by a system for troubleshooting a computer is provided. The method performs the method steps according to one or more embodiments of the fourth aspect. The first text document comprises a log and the first topic comprises operation of the computer. The sensitive information for a second topic corresponds to computer-specific sensitive information. The sensitive information for a third topic corresponds to personally identifiable information. The method further comprises performing a troubleshooting activity prior to performing or after performing all steps configured to be performed by the apparatus.

According to a sixth aspect of the invention, a computer program is provided. The computer program comprises instructions, which when executed on at least one processor, causes the at least one processor to perform the steps according to one or more embodiments of the fourth aspect of the invention.

According to a seventh aspect of the invention, a computer program is provided. The computer program comprises instructions, which when executed on at least one processor, causes the at least one processor to perform the steps according to the fifth aspect of the invention.

According to an eighth aspect of the invention, a computer readable storage medium is provided. The computer readable storage medium comprises a computer program according to the sixth aspect of the invention, and/or the seventh aspect of the invention.

At least one or more embodiments advantageously enable detection of sensitive information, and improve privacy and security of data.

At least one or more embodiments advantageously leverage the combination of structure of sensitive information with contextual semantic matching.

At least one or more embodiments provide efficient anonymization or pseudonymization of sensitive information.

At least one or more embodiments provide a scalable and time-efficient solution that minimizes manual labor and resource costs.

Further objectives of, features of, and advantages with, the invention will become apparent when studying the following detailed disclosure, the drawings, and the appended claims. Those skilled in the art realize that different features of the invention can be combined to create embodiments other than those described in the following.

### BRIEF DESCRIPTION OF THE DRAWINGS

The above, as well as additional objects, features and advantages of the invention, will be better understood through the following illustrative and non-limiting detailed description of embodiments of the invention, with reference to the appended drawings, in which:

FIG. 1 shows a method 100 for detecting sensitive information in a first text document representative of a first topic according to an embodiment of the invention.

FIG. 2 shows a method 200 for troubleshooting a computer according to an embodiment of the invention.

FIG. 3 shows a block diagram of an apparatus for detecting sensitive information in a first text document representative of a first topic according with an embodiment of the invention.

FIG. 4 shows a block diagram of a system for troubleshooting a computer according to an embodiment of the invention.

FIG. 5 shows a block diagram of an apparatus for detecting sensitive information in a first text document representative of a first topic according with an embodiment of the invention.

FIG. 6 shows a block diagram of a system for troubleshooting a computer according to an embodiment of the invention.

FIG. 7 shows an embodiment exemplifying step 110 of method 100.

FIG. 8 shows an embodiment exemplifying the list of one or more types of sensitive information for a second topic.

FIG. 9 shows an embodiment of step 120 of the method 100.

FIG. 10 shows an embodiment of step 120 of the method 100.

FIG. 11 shows an embodiment of the list of one or more sensitive information for a third topic.

FIG. 12 shows an embodiment of a language model.

FIG. 13 shows a block diagram illustrating a virtualization environment QQ500 in which method steps implemented by some embodiments may be virtualized.

All figures are schematic, and generally only show parts which are necessary in order to elucidate the invention, wherein other parts may be omitted or merely suggested.

### DETAILED DESCRIPTION

The invention will now be described more fully herein with reference to the accompanying drawings, in which certain embodiments are shown. This invention may, however, be embodied in many different forms and should not be construed as limited to the embodiments set forth herein. Rather, these embodiments are provided by way of example so that this disclosure will be thorough and complete, and will fully convey the scope of the invention to those skilled in the art.

The invention disclosed herein may be used for improving security and privacy related to text documents.

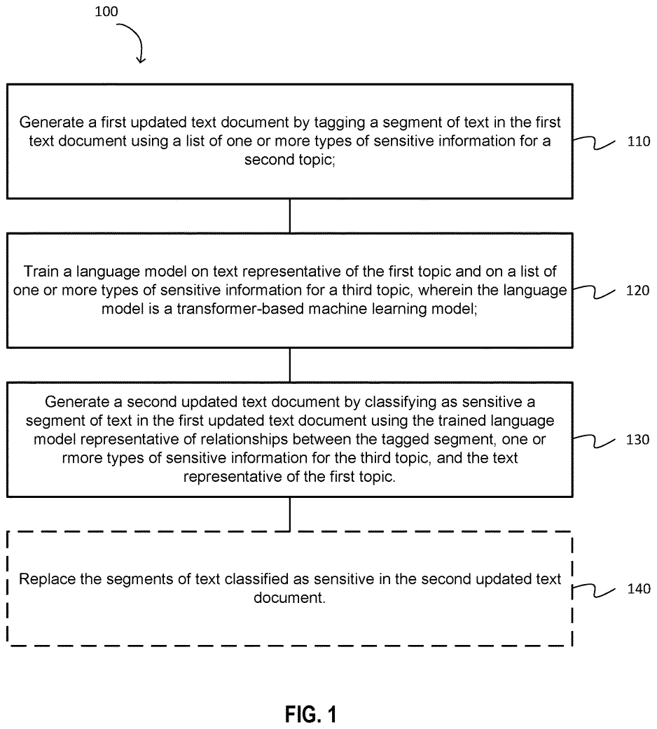

In FIG. 1, a flowchart depicting embodiment of a method 100 is provided. The method 100 is performed for detecting sensitive information in a first text document 710 representative of a first topic. The method may be performed by an apparatus 300.

In an embodiment, the first topic comprises operation of a computer. The computer may be an electronic device for storing and processing data, in binary form, according to instructions given to the computer in a variable program. The computer may be comprised in a network node. The network node refers to equipment capable, configured, arranged and/or operable to communicate directly or indirectly with a user equipment (UE) and/or with other network nodes or equipment in a wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. The network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a UE with access to the wireless network or to provide some service to a UE that has accessed the wireless network.

In an embodiment, the first text document 710 is a computer-generated data file. The computer-generated data file may comprise, for example, textual information about one or more of: usage patterns, activities, operations within an operating system, application, server or another device. For example, the first text document 710 is a log message. The log message may comprise a message in descriptive text format. The log message may record either events that occur in an apparatus or other computerized system. The log may also be generated by a computer program, indicating events descriptive of operation of the computer program or the computer, device or system executing the computer program. The log message may be designed for troubleshooting. The log message may comprise sensitive information. The log message may comprise a Continuous Integration/Continuous Delivery (CI/CD) flow execution log file. The log message may comprise text in natural language, such as English, German, Swedish or other. The log message may comprise one or more events representing operational status or state of the computer. The one or more events may represent any one or more of: an activity of the computer, such as its operational state, action undertaken, start of action, end of action, result of action, and/or and other operational parameters. Each of the one or more events may comprise a plurality of fields where each respective field stores different information. For example, event fields may correspond to one or more of: date, event type, module name, submodule, process, Internet Protocol (IP) address, event message, test result, location, priority, function, status, software version.

The method 100 comprises generating 110 a first updated text document 720 by tagging a segment 730 of text in the first text document 710 using a list 740 of one or more types of sensitive information for a second topic. The second topic may correspond to telecommunication, such as radio access network information, network node data. The sensitive information for the second topic may correspond to computer, manufacturer of the computer or organization-specific sensitive information.

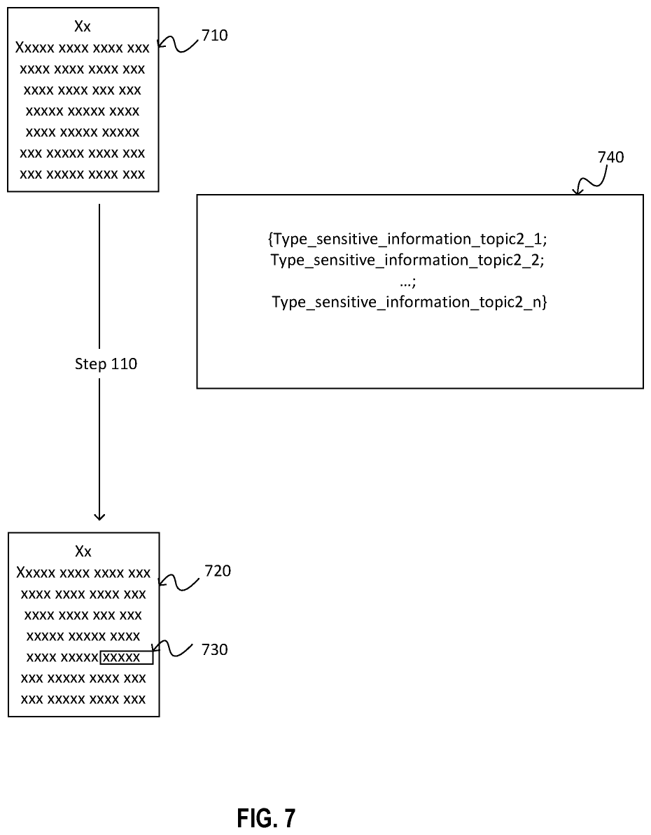

In FIG. 7, an embodiment exemplifying step 110 of method 100 is illustrated. In one embodiment, the first text document 710 and the first updated text document 720 may be the same computer-generated data file. In such a case, a segment 730 of the text is replaced or annotated with a label or annotation corresponding to the type of sensitive information. In another embodiment, the first text document 710 and the first updated text document 720 are the same computer-generated data file with the exception that a segment 730 of the text comprises metadata defining the type of the sensitive information of the tagged segment 730 of the text. The metadata may correspond to one of the one or more types of the list 740 of one or more types of sensitive information for the second topic. The one or more types of sensitive information for the second topic may comprise one or more of: an Internet Protocol (IP) address, a company product software name, company software version. In yet another embodiment, the first text document 710 and the first updated text document 720 are separate data or text files.

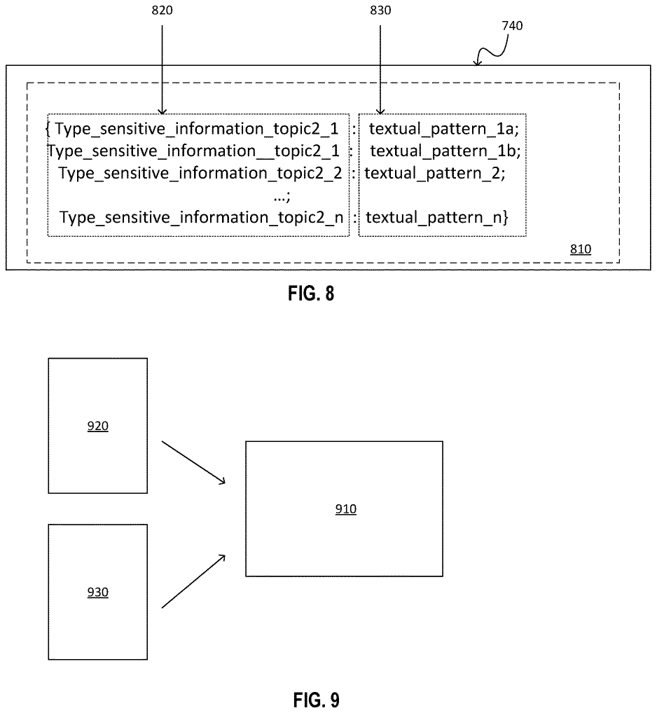

In FIG. 8, an embodiment exemplifying the list 740 of one or more types of sensitive information for the second topic is illustrated. The list 740 of the one or more types of sensitive information for the second topic may comprise a dictionary 810 of one or more records. One or more records of the dictionary 810 may define a type 820 of sensitive information for the second topic and corresponding textual pattern 830 for identifying said type in text. The skilled person would understand that it is possible to have more than one textual pattern corresponding to a type of sensitive information. The one or more types 820 of sensitive information for the second topic may correspond to the one or more types of sensitive information for the second topic in the list 740. The textual pattern may comprise a regular expression (RegEx) or another type of textual pattern. Another type of textual pattern may be a template from templating language such as Artificial Intelligence Markup Language (AIML). For example, a regular expression for an IP address may be \hat{ }(?: [0-9] {1,3} \.) {3} [0-9] {1,3} $. For example, a regular expression for a company software name may be (CXP [0-9] */[0-9] *) \s+ (R[0-9a-zA-Z] *). Table 1 illustrate an example of the dictionary 810 comprising ‘IP address’ type and ‘company software name’ type with respective textual pattern.

TABLE 1
an example of the dictionary 810.

| Type of sensitive information | |
|---|---|
| for the second topic | RegEx |
| IP address | \hat{ }(?:[0-9]{1, 3}\.){3}[0-9]{1, 3}$ |
| Company software name | (CXP[0-9]*/[0-9]*)\s + (R[0-9a-zA-Z]*) |

Thus, step 110 allows to identify company-specific or domain-specific entities e.g., IP address, that can be easily detected using a set of pre-defined rules, or naming convention adopted in certain field.

In an example, the first text document 710 is:
Magnus Ericsson founded Ericsson 100 years ago at his home Torshamnsgatan 21, Sweden his IP address was 123.123.123.123.

In this same example, after step 110 of the method 100 is performed, the first updated text document 720 is:
Magnus [Name] Ericsson [Organization] founded Ericsson[Organization] 100 years ago at his home Torshamnsgatan [Street] 21 [Number], Stockholm [City]. His IP address was 123.123.123.123 [IP address].

The method 100 comprises training 120 a language model 910 on text 920 representative of the first topic and on a list 930 of one or more types of sensitive information for a third topic. The language model 910 is a transformer-based machine learning model. The sensitive information for the third topic may correspond to personally identifiable information. The personally identifiable information may correspond to sensitive data that could be used to identify, contact, and/or location an individual and/or enterprise. In FIG. 9, an embodiment of step 120 of the method 100 is provided.

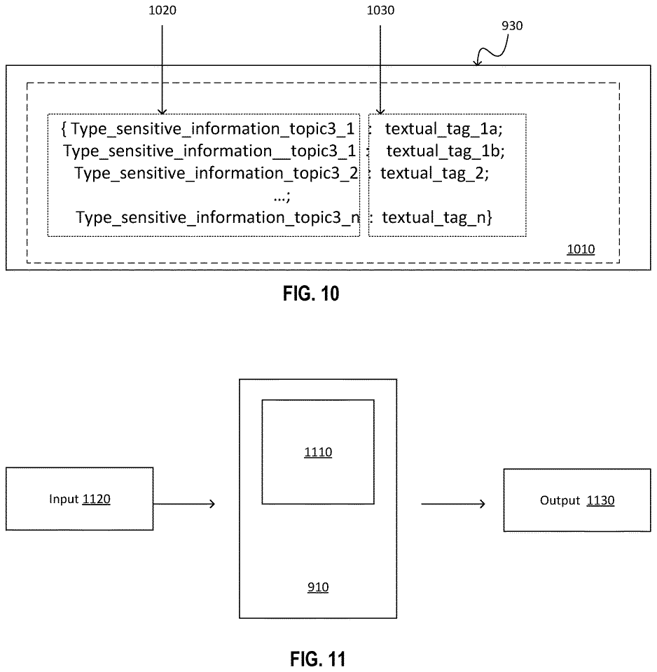

In FIG. 10, an embodiment of the list 930 of one or more sensitive information for the third topic is provided. The list 930 of one or more types of sensitive information for the third topic may comprise a dictionary 1010 of one or more records. One or more records of the dictionary 1010 may define a type 1020 of sensitive information for the third topic and corresponding textual tag 1030 for tagging text using said type 1020. The one or more type 1020 of sensitive information for the third topic may comprise one or more of: business phone number, race, religion, gender, name, workplace, job title, address. The one or more type 1020 of sensitive information for the third topic may correspond to one or more named entity recognition (NER) types. In other words, a combination of one or more NER types may correspond to a type 1020 of sensitive information for the third topic. The combination of one or more NER types may be a NER structure. For example, in Table 2:
the NER structure [IP address] corresponds to the ‘IP address’ type of sensitive information for the third topic;
the NER structure [Street]+ [Number]+ [City]+ [Country] corresponds to the ‘personal address’ type of sensitive information for the third topic;
the NER structure [Street]+ [City]+ [Country] corresponds to the ‘personal address’ type of sensitive information for the third topic.

TABLE 2
an illustration of correspondence of type of sensitive
for the third topic and NER structures.

| Type of sensitive information | |
|---|---|
| for the third topic | NER structure |
| IP address | [IP address] |
| Personal address | [Street] + [Number] + [City] + [Country] |
| Personal address | [Street] + [City] + [Country] |

In FIG. 11, an embodiment of the language model is provided. As stated above, the language model is a transformer-based machine learning model 910. The transformer-based machine learning model 910 may comprise a Bidirectional Encoder Representations from Transformer (BERT), such as the BERT defined in DEVLIN J., CHANG M., LEE K., and TOUTANOVA K., “BERT: pre-training of deep learning transformers for language understanding”, May 2019. A BERT model is designed to pretrain deep bidirectional representations from unlabeled text by jointly conditioning on both left and right context in all layers, so as to have the pre-trained BERT model be fine-tuned with just one additional output layer. The additional output layer corresponds to a final layer. The final layer of the transformer-based machine learning model 910 may comprise a binary class tagging layer 1110. The binary class tagging layer 1110 may comprise two classes. The two classes correspond respectively to ‘sensitive’ and ‘non-sensitive’. ‘Sensitive’ characterizes sensitive information (e.g., data that has to be protected to safeguard privacy and security of an individual or organization). An input 1120 of the transformer-based machine learning model 910 may be the first updated text document 720. The transformer-based machine learning model 910 is used to identify one or more tagged segments in the first updated text document 720 as sensitive.

In an embodiment, the method 100 comprises building a lookup-table, such as illustrated in Table 3. The lookup illustrated in Table 3 allows to identify sensitive information based on the NER structure and on the type 1010 of sensitive information for the third topic.

TABLE 3
an illustration of the lookup table.

| Type of sensitive | | |
|---|---|---|
| information for the | | |
| third topic | NER structure | classification |
| IP address | [IP address] | Sensitive |
| Personal address | [Street] + [Number] + [City] + | Sensitive |
| | [Country] | |
| Personal address | [Street] + [City] + [Country] | Sensitive |

The method 100 comprises generating 130 a second updated text document 1210 by classifying as sensitive a segment of text 730 in the first updated text document 720 using the trained language model 910 representative of semantic relationships between the tagged segment 730, one or more types 1020 of sensitive information for the third topic, and the text representative 920 of the first topic. A combination of a plurality of tagged segments in the first updated text document may correspond to a type of sensitive information for the third topic. For example, in relation with Table 3, a combination of [Street], and [City], and [Country] corresponds to the “address” type, the combination of segments of text tagged as [Street], and [City], and [Country] may be classified as “sensitive”.

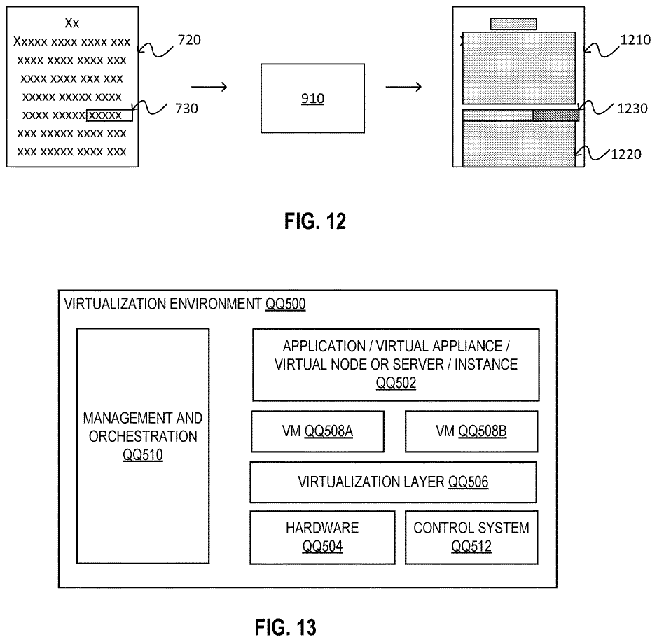

In FIG. 12, an example of the step 130 of the method 100 is provided. The first updated text document 720 corresponds to the input of the trained language model 910. The second updated text document 1210 corresponds to the output of the trained language model 910. The tagged segment 730 in the first updated text document 720 corresponds to a type 1010 of sensitive information for the third topic. In one embodiment, the first updated text document 720 and the second updated text document 1210 may be the same computer-generated data file. In such a case, the tagged segment of the text 730 is replaced or annotated with a classification 1230 corresponding to ‘sensitive’. In another embodiment, the first updated text document 720 and the second updated text document 1210 are the same computer-generated data file with the exception that a segment 730 of the text comprises metadata defining the tagged segment 730 of the text as ‘sensitive’ and the rest of the text comprises metadata defining the rest of the text as ‘non-sensitive’. The metadata may correspond to either ‘sensitive’ or ‘non-sensitive’. In yet another embodiment, the first updated text document 720 and the second updated text document 1210 are separate data or text files.

Continuing from the previous example, the first text document 710 is:
Magnus Ericsson founded Ericsson 100 years ago at his home Torshamnsgatan 21, Sweden his IP address was 123.123.123.123.

In this same example, after the step 110 of the method 100 is performed, the first updated text document 720 is:
Magnus [Name] Ericsson [Organization] founded Ericsson[Organization] 100 years ago at his home Torshamnsgatan [Street] 21 [Number], Stockholm [City]. His IP address was 123.123.123.123 [IP address].

In this same example, after the step 130 of the method 100 is performed, the second updated text document 1210 is:
[Magnus Ericsson]-[sensitive] [founded Ericsson]-[non-sensitive] [100 years ago at his home] [non-sensitive] [Torshamnsgatan 21 Stockholm]-[sensitive]. [His IP address was]-[non-sensitive] [123.123.123.123]-[sensitive].

In this example, the trained language model 910 has identified as a ‘personal address’ the combination of NER type [Street]+ [Number]+ [City], and has classified the ‘personal address’ as ‘sensitive’.

In an embodiment, the method 100 comprises replacing 140 the segments of text classified as sensitive in the second updated text document. Replacing 140 may comprise anonymizing the segments of text classified as sensitive in the second updated text document. In other words, the segments of text classified as sensitive in the second updated text document 1210 are securely deleted. Anonymization of data, such as anonymizing the segments of text classified as sensitive in the second updated text documents, prevents reversing the replacement process. Replacing 140 may comprise pseudo-anonymizing the segments of text classified as sensitive in the second updated text document 1210. In other words, the segments of text classified as sensitive in the second updated text document 1210 may be partially retrieved, for example by accessing the lookup table illustrated in Table 3. In another example, the segments of text classified as sensitive in the second updated text document 1210 may be partially retrieved, for example by using hash keys.

In the following, by reference to the previous example, a replacement of the step 140 of the method 100 is illustrated. After the step 130 of the method 100 is performed, the second updated text document 1210 is:
[Magnus Ericsson]-[sensitive] [founded Ericsson]-[non-sensitive] [100 years ago at his home] [non-sensitive] [Torshamnsgatan 21, Stockholm]-[sensitive]. [His IP address was]-[non-sensitive] [123.123.123.123]-[sensitive].

The segments of text classified as sensitive in the second updated text document 1210 are replaced to obtain:
John Doe founded Ericsson 100 years ago at his home Nirvana. His IP address was xyz.

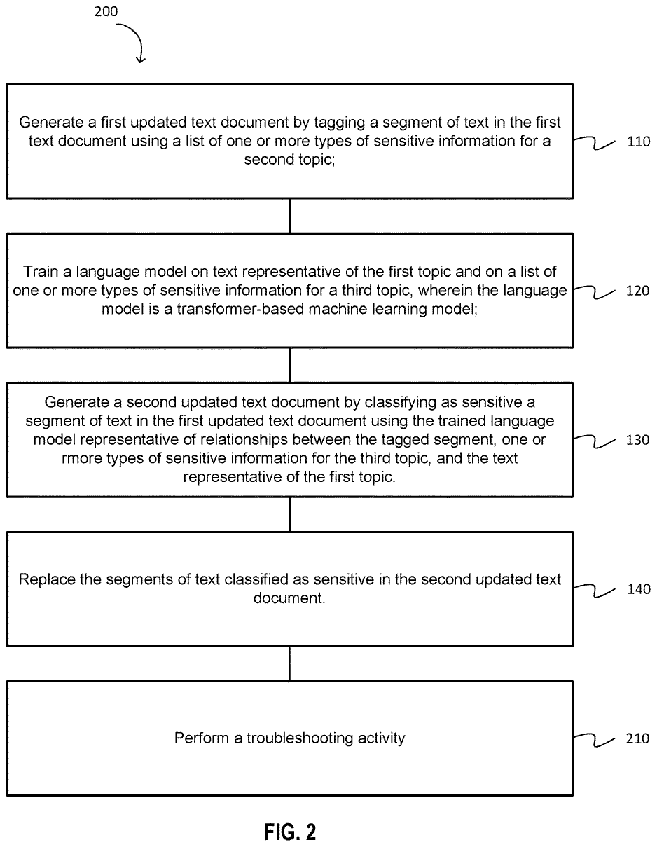

In FIG. 2, a flowchart depicting embodiments of a method 200 is provided. The method 200 may be performed by a system 400. The system 400 comprises the apparatus 300. The method 200 is performed for troubleshooting the computer. Troubleshooting may comprise analyzing the log messages, tracing errors identified in the log messages so as to correct the mechanism of the computer. for example, telecommunication software and/or hardware vendors deliver software and/or hardware solutions. When the software and/or hardware solutions are deployed in the real world, the software and/or hardware solutions may experience problems. The software and/or hardware vendors help their customers to identify faults and understand the cause behind system failure and service problem. For instance, a network engineer rely on logs to track what is happening in the software and/or hardware solution. Such logs can contain sensitive information.

The method 200 comprises the step 110 of the method 100 as described above.

The method 200 comprises the step 120 of the method 100 as described above.

The method 200 comprises the step 130 of the method 100 as described above.

The method 200 comprises the step 140 of the method 100 as described above.

The method 200 comprises performing 210 a troubleshooting activity. In an embodiment, the step 210 of the method 200 may be performed prior to performing the step 110 of the method 110, the step 120 of the method 120, the step 130 of the method 100, and the step 140 of the method 100. In another embodiment, the step 210 of the method 200 is performed after performing the step 110 of the method 110, the step 120 of the method 120, the step 130 of the method 100, and the step 140 of the method 100. The troubleshooting activity may comprise an instruction or a command directed at resolving a root cause of a failed text in the computer.

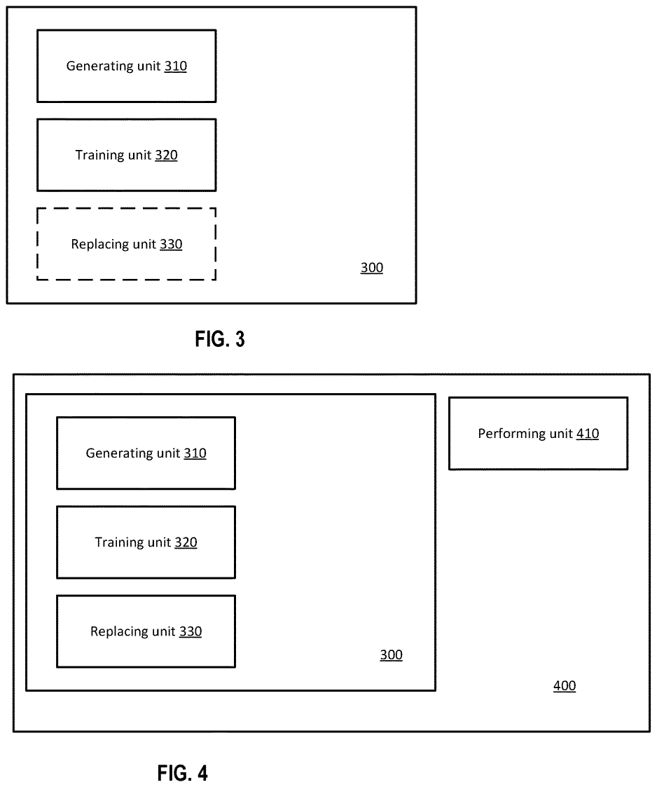

In FIG. 3, a block diagram of the apparatus 300 for detecting sensitive information in a first text document representative of the first topic is provided.

In an embodiment, the apparatus 300 is a network node. The network node refers to equipment capable, configured, arranged and/or operable to communicate directly or indirectly with a wireless device and/or with other network nodes or equipment in a wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs).

Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, the network node may be a virtual network node. More generally, however, network nodes may represent any suitable device (or group of devices) capable, configured, arranged, and/or operable to enable and/or provide a wireless device with access to the wireless network or to provide some service to a wireless device that has accessed the wireless network.

The apparatus 300 comprises a generating unit 310. The generating unit 310 is configured to perform the step 110 of the method 100 as described above. The generating unit 310 is configured to perform the step 130 of the method 100 as described above.

The apparatus 300 comprises a training unit 320. The training unit 320 is configured to perform the step 120 of the method 100 as described above.

In an embodiment, the apparatus 300 comprises a replacing unit 330. The replacing unit is configured to perform the step 140 of the methos 100 as described above.

In an embodiment, the generating unit 310, the training unit 320, and the replacing unit 330 may be integrated into a single unit.

The generating unit 310 may be implemented as a hardware solution or a combination of software and hardware, e.g., by one or more of: a processor or a micro-processor and adequate software and memory for storing of the software, a Programmable Logic Device (PLD), or other electronic component(s), or processing circuitry configured to perform the steps performed with regards to the method 100.

The training unit 320, and/or the replacing unit 330 may be implemented as a hardware solution or a combination of software and hardware, e.g., by one or more of: a processor or a micro-processor and adequate software and memory for storing of the software, a Programmable Logic Device (PLD), or other electronic component(s), or processing circuitry configured to perform the steps performed with regards to the method 100.

In FIG. 4, a block diagram of the system 400 for troubleshooting the computer is provided.

The system 400 comprises the apparatus 300.

The apparatus 300 comprises a generating unit 310. The generating unit 310 is configured to perform the step 110 of the method 100 as described above. The generating unit 310 is configured to perform the step 130 of the method 100 as described above.

The apparatus 300 comprises a training unit 320. The training unit 320 is configured to perform the step 120 of the method 100 as described above.

The apparatus 300 comprises a replacing unit 330 is configured to perform the step 140 of the method 100 as described above.

The system 400 comprises a performing unit 410. The performing unit 410 is configured to perform the step 210 of the method 200 as described above.

In an embodiment, the generating unit 310, the training unit 320, the replacing unit 330, and the performing unit 410 may be integrated into a single unit.

The generating unit 310, the training unit 320, and/or the replacing unit 330 may be implemented as a hardware solution or a combination of software and hardware, e.g., by one or more of: a processor or a micro-processor and adequate software and memory for storing of the software, a Programmable Logic Device (PLD), or other electronic component(s), or processing circuitry configured to perform the steps performed with regards to the method 100.

The performing unit 410 may be implemented as a hardware solution or a combination of software and hardware, e.g., by one or more of: a processor or a micro-processor and adequate software and memory for storing of the software, a Programmable Logic Device (PLD), or other electronic component(s), or processing circuitry configured to perform the steps performed with regards to the method 200.

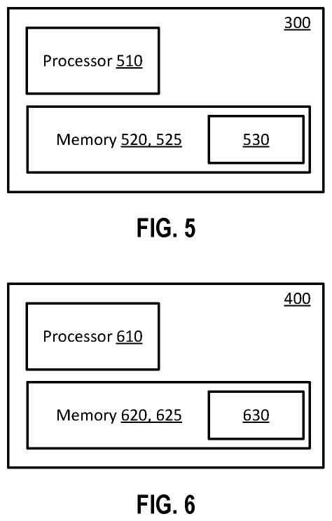

In FIG. 5, an embodiment of the apparatus 300 is provided. The apparatus 300 comprises a processor 510, and a computer readable storage medium 520 in the form of a memory 525. The memory 525 contains a computer program 530 comprising instructions executable by the processor 510 whereby the apparatus 300 is operative to perform the steps of the method 100 as described above.

In FIG. 6, an embodiment of the system 400 is provided. The system 400 comprises a processor 610, and a computer readable storage medium 620 in the form of a memory 625. The memory 625 contains a computer program 630 comprising instructions executable by the processor 610 whereby the system 400 is operative to perform the steps of the method 200 as described above.

The (non-transitory) computer readable storage media, mentioned above in relation to FIG. 5 and FIG. 6, may be an Electrically Erasable Programmable Read-Only Memory (EEPROM), a flash memory, Field Programmable Gate Array, and a hard drive.

The processor 510 of FIG. 5, and the processor 610 of FIG. 6, may be a single CPU (Central processing unit), but could also comprise two or more processing units. The processor 610 may comprise a plurality of distributed processing units, for example across communicatively coupled network nodes as part of distributed computing or cloud architecture. For example, the processor 510 of FIG. 5, and the processor 610 of FIG. 6 may include general purpose microprocessors; instructions set processors and/or related chips sets and/or special purpose microprocessors such as Application Specific Integrated Circuit (ASICs). The processor 510 of FIG. 5 and the processor 610 of FIG. 6 may also comprise board memory for caching purposes.

The computer program 530 of FIG. 5, and the computer program 630 of FIG. 6 may be carried by a computer program product connected to the processor 510 of FIG. 5, and the processor 610 of FIG. 6. The computer program product may be or comprise a non-transitory computer readable storage medium on which the computer programs 530 of FIG. 5 and the computer program 630 of FIG. 6 are stored. For example, the computer program products may be a flash memory, a Random-access memory (RAM), a Read-Only memory (ROM), or an EEPROM, and the computer programs described above could in alternative embodiments be distributed on different computer program products in the form of memories.

In FIG. 13, a block diagram illustrating a virtualization environment QQ500 in which method steps implemented by some embodiments may be virtualized. In the present context, virtualizing means creating virtual versions of apparatus 300 or system 400 which may include virtualizing hardware platforms, storage devices and networking resources. As used herein, virtualization can be applied to apparatus 300 or system 400 described herein, or components thereof, and relates to an implementation in which at least a portion of the functionality is implemented as one or more virtual components. Some or all of the method steps described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment QQ500 to implement some of the method steps, features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the method steps, functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

As used herein, the term “and/or” includes any and all combinations of one or more of the associated listed terms. The terminology used herein is for the purpose of describing particular embodiments only and is not intended to be limited of example embodiments. As used herein, the single forms “a”, “an”, and “the” are intended to include the plural forms as well, unless the context clearly indicated otherwise. It will be further understood that the terms “comprises”, “comprising”, “has”, “having”, “includes”, and/or “including”, when used herein, specify the presence of stated features, elements, and/or components etc. but do not preclude the presence or addition of one or more other features, elements, components, and/or combinations thereof.

This disclosure has been described above in reference to embodiments thereof. It should be understood that various modifications, alternatives, and additions can be made by those skilled in the art without departing from the scope of the disclosure. Therefore, the scope of the disclosure is not limited to the above particular embodiments but only defined by the claims as attached.

1-21. (canceled)

22. An apparatus for detecting sensitive information in a first text document representative of a first topic, the apparatus comprising processing circuitry and a memory, the memory containing instructions executable by the processing circuitry, the apparatus being configured to:
generate a first updated text document by tagging a segment of text in the first text document using a list of one or more types of sensitive information for a second topic, wherein the second topic is distinct from the first topic;
train a language model on text representative of the first topic and on a list of one or more types of sensitive information for a third topic, wherein the third topic is distinct from the first topic and the second topic, and wherein the language model is a transformer-based machine learning model; and
generate a second updated text document by classifying as sensitive a segment of text in the first updated text document using the trained language model representative of semantic relationships between the tagged segment, one or more types of sensitive information for the third topic, and the text representative of the first topic.

23. The apparatus according to claim 22, wherein the transformer-based machine learning model comprises a Bidirectional Encoder Representations from Transformers (BERT), and wherein the final layer of the model comprises a binary class tagging layer.

24. The apparatus according to claim 22, wherein the list of the one or more types of sensitive information for the second topic comprises a dictionary of one or more records, wherein each record defines a type of sensitive information and corresponding textual pattern for identifying said type in text.

25. The apparatus according to claim 22, wherein the list of the one or more types of sensitive information for the third topic comprises a dictionary of one or more records, wherein each record defines a type of sensitive information and corresponding textual tag for tagging text using said type.

26. The apparatus according to claim 22, wherein the apparatus is further configured to replace the segments of text classified as sensitive in the second updated text document.

27. The apparatus according to claim 26, wherein the replacing comprises anonymizing the segments of text classified as sensitive in the second updated text document.

28. The apparatus according to claim 26, wherein the replacing comprises pseudo-anonymizing the segments of text classified as sensitive in the second updated text document.

29. A system for troubleshooting a computer, the system comprising the apparatus according to claim 26, wherein:
the first text document comprises a log and the first topic comprises operation of the computer;
the sensitive information for a second topic corresponds to computer-specific sensitive information;
the sensitive information for a third topic corresponds to personally identifiable information; and
wherein the system is further configured to perform a troubleshooting activity prior to performing or after performing all steps configured to be performed by the apparatus.

30. A method performed by an apparatus for detecting sensitive information in a first text document representative of a first topic, the method comprising:
generating a first updated text document by tagging a segment of text in the first text document using a list of one or more types of sensitive information for a second topic, wherein the second topic is distinct from the first topic;
training a language model on text representative of the first topic and on a list of one or more types of sensitive information for a third topic, wherein the third topic is distinct from the first topic and the second topic, and wherein the language model is a transformer-based machine learning model; and
generating a second updated text document by classifying as sensitive a segment of text in the first updated text document using the trained language model representative of semantic relationships between the tagged segment, one or more types of sensitive information for the third topic, and the text representative of the first topic.

31. The method according to claim 30, wherein the transformer-based machine learning model comprises a Bidirectional Encoder Representations from Transformers (BERT), and wherein the final layer of the model comprises a binary class tagging layer.

32. The method according to claim 30, wherein the list of the one or more types of sensitive information for the second topic comprises a dictionary of one or more records, wherein each record defines a type of sensitive information and corresponding textual pattern for identifying said type in text.

33. The method according to claim 30, wherein the list of the one or more types of sensitive information for the third topic comprises a dictionary of one or more records, wherein each record defines a type of sensitive information and corresponding textual tag for tagging text using said type.

34. The method according to claim 30, further comprising replacing the segments of text classified as sensitive in the second updated text document.

35. The method according to claim 34, wherein the replacing comprises anonymizing the segments of text classified as sensitive in the second updated text document.

36. The method according to claim 34, wherein the replacing comprises pseudo-anonymizing the segments of text classified as sensitive in the second updated text document.
